(19) United States
(12) Patent Application Publication
(10) Pub. No.: US 2002/0025040 A1
(43) Pub. Date: Feb. 28, 2002

(54) Method and apparatus for generating an encryption key

(76) Inventor: Howard Stein, Fair Oaks, CA (US)

Correspondence Address: Mark C. Pickering, 5th Floor, 50 Fremont Street, San Francisco, CA, 94105, US

(21) Appl. No.: 09/981,501

(22) Filed: Oct. 17, 2001

Related U.S. Application Data
(63) Continuation-in-part of application No. 09/605,290, filed on Jun. 28, 2000.

(51) Int. Cl. H04L 9/00; H04K 1/00

(52) U.S. Cl. 380/45; 713/183

(57) ABSTRACT

An encryption key is formed by a method and apparatus that read a sequence of bytes from a memory. The sequence of bytes, which is larger than the number of bytes in the encryption key, is randomly ordered due to the source of the sequence. Each byte in the sequence is assigned to one of a number of groups where the number of groups is defined by the number of bytes in the encryption key. Each group is then reduced to a single byte to form one of the bytes of the encryption key.

### RELATED APPLICATION

The present application is a continuation-in-part of application Ser. No. 09/605,290 for Encrypting Security Device and Process filed on Jun. 28, 2000 by Howard Stein, which claims priority from Provisional Application Ser. No. 60/141,274 for Description of Encryption Process for Computers, Computer Programs, Automobile Entry and Starting Systems, and Encrypting Gun Mechanisms to Restrict Firing filed on Jun. 30, 1999 by Howard Stein.

### BACKGROUND OF THE INVENTION

1. Field of the Invention

The present invention relates to encryption and, more particularly, to a method and an apparatus that generate an encryption key.

2. Description of the Related Art

Data security is commonly implemented by limiting access to a computer, and encrypting data that is received, stored, and transmitted by the computer. Access to a computer is typically handled by requiring the user to enter a username and password or passkey. In addition to using a passkey, user carried security devices are also known.

However, no currently existing security device utilizes a photograph, with its multiplicity of randomly placed picture elements, to limit access to a computer. There are other security processes, which use words or graphics as a passkey, but hackers have broken into all of these because the underlying passkey is based upon linguistics or logic.

In addition, data held or transferred in electronic form is vulnerable to unauthorized review. When the subject matter of the data warrants the highest level of security, a number of steps, including encrypting the data, can be taken to limit the likelihood that an unauthorized review will occur.

Data encryption is a process where the binary values that make up the data are rearranged in a defined way so that the binary values produce unintelligible results to an unauthorized reviewer. The encrypted data that results from the rearrangement, after storage or transfer, can then be arranged back to the original order so that authorized reviewers can review the data.

With data encryption, the binary values that make up the data are rearranged in a defined way using an encryption algorithm and an encryption key. The encryption key is a multi-byte file. The encryption algorithm uses the values of the bytes in the encryption key to determine how the data is rearranged. Thus, by changing the values of the bytes in the encryption key, the binary values can be rearranged in different ways.

There are generally two types of encryption keys: a memorized key and a recorded key. A memorized key is a key that a user has committed to memory. One significant weakness of a memorized key, however, is that most users utilize birthdays, social security numbers, phone numbers, and other easy to remember numbers as the key. Code breakers and hackers exploit this weakness to defeat the encryption.

A recorded key is a key that is held by a medium for future use, such as a key that has been written down, or saved onto a magnetic strip. Since a recorded key does not need to be remembered, a recorded key can be more complex than a memorized key. Although more complex, a recorded key can also be broken because the underlying key is based on linguistics or logic. Thus, there is a need for a method and apparatus that generate an encryption key that is not based on linguistics or logic.

### SUMMARY OF THE INVENTION

The present invention provides a method and apparatus that generate a multi-byte encryption key that is not based on linguistics or logic. In accordance with the present invention, a method of forming an encryption key that has a number of bytes includes the step of reading a sequence of bytes from a memory. The sequence of bytes has a number of bytes that is greater than the number of bytes in the encryption key. Further, the method includes the step of reducing the number of bytes in the sequence of bytes to be equal to the number of bytes in the encryption key.

In addition, the reducing step further includes the step of assigning each byte in the sequence of bytes to one of a number of groups so that each group has one or more bytes. The number of groups is equal to the number of bytes in the encryption key. Further, the reducing step also includes the step of reducing the number of bytes in each group to a single byte.

The present invention also includes an apparatus that forms an encryption key which has a number of bytes. The apparatus includes means for reading a sequence of bytes from a memory. The sequence of bytes has a number of bytes that is greater than the number of bytes in the encryption key. The apparatus also includes means for reducing the number of bytes in the sequence of bytes to be equal to the number of bytes in the encryption key.

In addition, the means for reducing further includes means for assigning each byte in the sequence of bytes to one of a number of groups so that each group has one or more bytes. The number of groups is equal to the number of bytes in the encryption key. Further, the means for reducing includes means for reducing the number of bytes in each group to a single byte.

A better understanding of the features and advantages of the present invention will be obtained by reference to the following detailed description and accompanying drawings that set forth an illustrative embodiment in which the principles of the invention are utilized.

### BRIEF DESCRIPTION OF THE DRAWINGS

FIG. 1 is a block diagram illustrating a computer 100 in accordance with the present invention.

FIG. 2 is a flow chart illustrating a method 200 that limits access to computer 100 in accordance with the present invention.

FIG. 3 illustrates a process for access to a computer using one embodiment of the described security device.

FIG. 4 illustrates a process of producing one embodiment of the present invention.

FIG. 5 is a flow chart illustrating a method 500 for forming an encryption key in accordance with the present invention.

### DETAILED DESCRIPTION

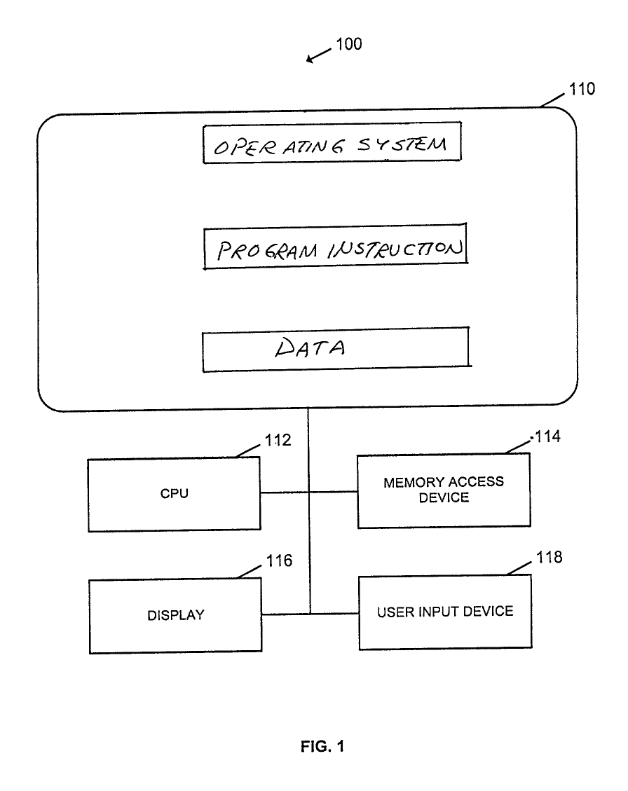

FIG. 1 shows a block diagram that illustrates a computer 100 in accordance with the present invention. As shown in FIG. 1, computer 100 includes a memory 110 that has an operating system block that stores an operating system, a program instruction block that stores program instructions, and a data block that stores data.

As further shown in FIG. 1, computer 100 also includes a central processing unit (CPU) 112 that is connected to memory 110. CPU 112, which can be implemented with, for example, a Pentium processor, controls the interaction between the internal components of the entire system in response to the program instructions and the data.

Further, computer 100 includes a memory access device 114, such as a card reader, a disk (e.g., floppy, CD, DVD) drive, or a networking card, which is connected to memory 110 and CPU 112. Memory access device 114 allows program instructions and data to be input to memory 110 from an external medium, such as a card, a disk, or a networked computer. In addition, memory access device 114 allows data from memory 110 or CPU 112 to be output to an external medium.

Computer 100 can further include a display system 116 that is connected to CPU 112. Display system 116 displays images to the users to interact with the programs. Computer 100 also includes a user-input device 118, such as a keyboard and a pointing device, which is connected to CPU 112. The users operate input device 118 to interact with the program.

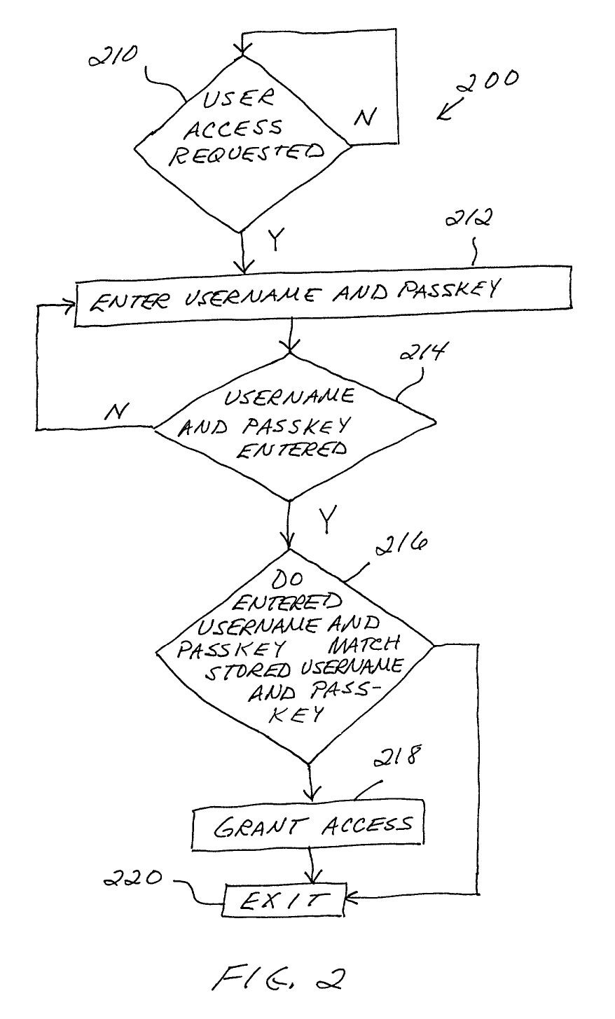

FIG. 2 shows a flow chart that illustrates a method 200 that limits user access to computer 100 in accordance with the present invention. Method 200 is implemented in software that can be executed by computer 100. As shown in FIG. 2, method 200 begins at step 210 by determining whether a user has requested access.

When access is requested, method 200 moves to step 212 where the user is requested to enter a username and passkey. Method 200 then moves to step 214 to determine if the user has entered the username and passkey. When the username and passkey have been entered, method 200 moves to step 216 to determine if the entered username and passkey match a stored username and passkey.

When the entered and stored username and passkey match, method 200 moves to step 218 where the user is granted access to computer 100. On the other hand, when the entered and stored username and passkey do not match, method 200 moves to step 220 to exit.

The entered and stored passkeys are randomly ordered sequences of bytes that are generated by digitizing a unique image. A unique image is an image that has a very high probability of never being re-imaged in exactly the same way.

The described invention in the parent application, in one preferred embodiment, is a security device comprising a photograph. The photograph necessarily incorporates a multiplicity of picture elements. An apparatus such as a computer or a computer program or another apparatus requiring access which can be secured is associated with the security device.

The apparatus is initialized such that a specific security photograph is required to access the apparatus or an aspect of the workings of the apparatus. In one embodiment, in order for the apparatus to be initialized the security photograph is scanned for initialization. Henceforth, the identical photograph must be scanned for access to the associated apparatus.

After the security photograph has been scanned, the security photograph is encrypted onto the computer hard disc as a program file for the purpose of blocking access to the computer. In one embodiment, the computer can henceforth not be booted up without first scanning an identical security photograph.

The direction given by the encryption program when the computer is turned on is to place a “security code” (security photograph) in a high resolution scanner so that the original photograph used to encrypt entry to the computer is compared with the security photograph being scanned. The two photographs must match exactly for the computer to become functional and allow a user to access the programs. The requirements for the two photographs to match can require a high level of detail.

This process could further be used to access individual programs or files on the hard drive of the computer. The process could also be used to protect already existing programs or files. This is a unique process by which any user can prevent others from operating the users computer, programs and accessing data. In one embodiment, the following is required for access to a computer: 1) a computer; 2) an attached scanner; 3) a program which is initialized by the user to recognize a scan of a photograph; and 4) a photograph.

The process requires a program, which requires the user to insert a passkey device into the scanner, which the program will thereafter use to compare in order for any user to start the computer. Once the user has scanned the passkey device into the program the computer will not boot without the passkey device being inserted into the scanner, being recognized as the correct device by the program, and the program then allowing the computer to boot.

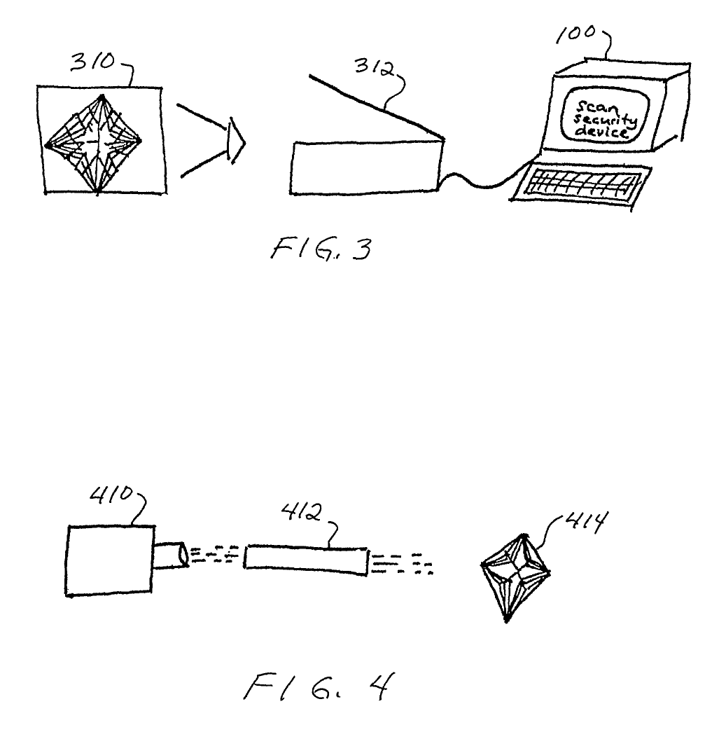

FIG. 3 illustrates an exemplary process of using an embodiment of the described security device. In FIG. 3, a security photograph 310 of an enlarged gemstone is placed in high-resolution scanner 312. Scanner 312 is connected with computer 100. When security photograph 310 is initially placed in scanner 312, computer 100 is initialized to require security photograph 310 as a passkey equivalent. Thereafter, the insertion of security photograph 310 in scanner 312 allows access to computer 100.

In one preferred embodiment of the parent application, security photograph 310 is an enlargement of a photograph of the center of a gemstone. A highly magnified interior of a gem is non-logical. As a result, a decoding device cannot use a logic based replacement program to determine what pattern the magnification of the internal structure of a gem will have. To break the code, a hacker must know exactly which gem has been used, the exact angle from which the picture of the gem was taken and the exact level of magnification used in the original passkey device.

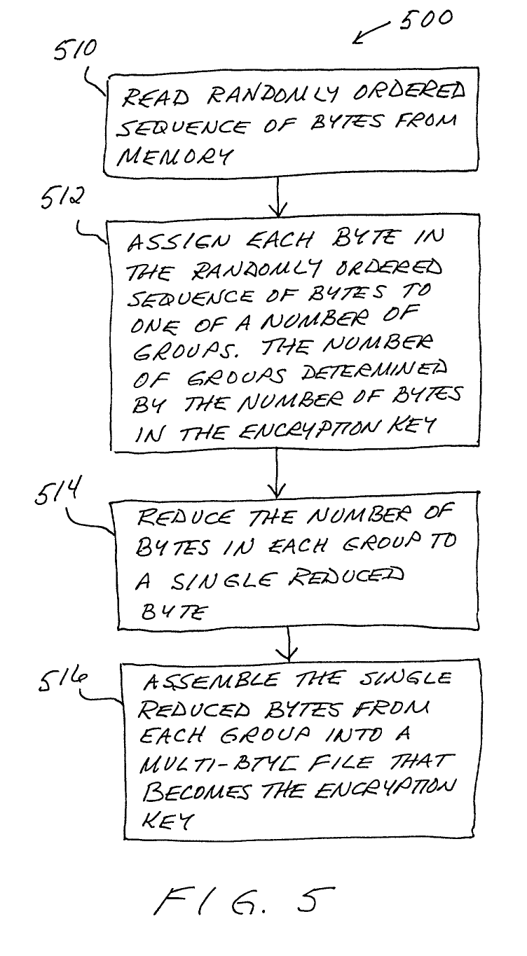

FIG. 4 illustrates the process used to obtain the security photograph in one embodiment of the invention. Camera 410 is attached to microscope 412. Camera 410 is employed to take a picture of an enlargement of the center of gemstone 414 (a cut diamond, emerald, ruby or other gem).

The enlargement used can be from a 10 to 40 power, in industry standard, or from two power to infinity depending on the level of random variability desired by the user for the security photograph. The resulting picture can either be a transparency or a print. Once the security photograph has been selected, it is developed through ordinary film development processes.

Magnification of gemstone 414 is required because no two gems have identical internal structure and the greater the degree of magnification the greater the unpredictable variations of such internal structure will be revealed thus making duplication of the security photograph impossible.

A picture taken of the same gem using different magnification or which is taken from a different angle, no matter how minutely at variance from the original, will not be recognized by the program as the correct security photograph and the apparatus associated with the security photograph will not start.

For this embodiment of the security device the picture of the center of any polished gem could be used. Further, a piece of granite could be cut into pieces and enlarged photographs of the unique structural surface of the granite could be used as a security photograph. No two security photographs would be exactly the same.

In another preferred embodiment of the parent application, the security photograph could comprise a magnified photograph of any suitable object. In another embodiment the security photograph could comprise any picture which comprises a multitude of random picture elements. For example, the picture can have an image of a person, or any part of a person, such as an image of a person except for the person's face. In addition, the image of the person can be the image of the authorized user, or any other person, such as a total stranger. The described security device can be used to secure a computer, a computer program, a vehicle of any description, a gun, a home, a cash register, a safe, or any other apparatus which requires secured access.

In a preferred embodiment of the parent application, the program in the security device process will allow the user several levels of security from which to choose. For example, the following options could be made available:

(1) a security photograph required prior to booting of the computer;

(2) the intermittent random scanning of the security photograph by the scanner at the direction of the program for so long as the computer is booted in order for it not to shut down (i.e., if the security photograph is removed from the scanner at any time the computer will either shut down or freeze until the security photograph is re-inserted); and

(3) a security photograph, or one or more different security photographs required for the user to use or continue to use different programs or data in the computer.

The described security photograph is not like any other security code because the complicated picture consists of so many thousands of randomly organized picture elements which cannot be decoded because they are in no logical order, nor do they consist of known alphabets or symbols. Even if an unauthorized user knew what the security photograph had been taken of, the security photograph could not be duplicated because the angle, distance and magnification would be different for each security photograph.

As noted above, the entered and stored passkeys are randomly ordered sequences of bytes that are generated by digitizing a unique image, such as the magnified image of the center of a gemstone. In addition to digitizing unique images, a randomly ordered sequence of bytes can also be obtained by digitizing recordings of unique sound events.

A unique sound event is a sound event that has a very high probability of never being repeated in exactly the same way. The probability, in turn, is a function of the duration of the sound event. The longer the duration of the sound event, the greater the likelihood that the sound event will never be repeated in exactly the same way.

A unique sound event can be recorded from a number of different sources, such as a human voice speaking a phrase. Although most people can easily recognize a well-known voice, when a voice speaking a phrase is repeatedly recorded with very sensitive equipment, it is highly unlikely that any two of the recordings will be exactly the same. This is because a large number of variables, including dust in the air, can effect the recording.

When a unique sound event is recorded and then digitized, the resulting digitized representation is a randomly ordered sequence of bytes because of the high probability that the unique sound event will never be repeated in exactly the same way. Thus, a randomly ordered sequence of bytes can be generated by digitizing a unique image, such as a magnified photograph of the interior of a gem, or a recording of a unique sound event, such as a human voice speaking a phrase.

As referred to above, to obtain entry to a secured computer, a security photograph is scanned to form a current randomly ordered sequence of bytes that represent the photograph. The current randomly ordered sequence of bytes is then compared to a stored randomly ordered sequence of bytes. The stored randomly ordered sequence of bytes, in turn, is the result of the original scan of the photograph that was used to encrypt entry to the computer. When the two randomly ordered sequence of bytes match, entry is permitted.

Alternately, rather than rescanning the security photograph each time entry to a secured device is desired, the randomly ordered sequence of bytes from the original scan can be stored in a non-volatile memory, and then later used as the source of the current randomly ordered sequence of bytes. For example, the randomly ordered sequence of bytes from the original scan can be magnetically, optically, magneto-optically, or electronically (e.g. flash cells) stored on a security card, disk, or other device, and then used when entry is desired.

Similarly, the randomly ordered sequence of bytes that results from digitizing a unique sound, such as the sound of a person speaking a phrase, can also be magnetically, optically, magneto-optically, or electronically stored on a security card, disk, or other device, and then used when entry is desired.

In addition to limiting access to a secured device, a randomly ordered sequence of bytes can also be used to encrypt data for storage or transmission. As discussed above, data is encrypted for storage or transmission by using an encryption algorithm and a multi-byte encryption key. In the present invention, a randomly ordered sequence of bytes is used to form the encryption key.

FIG. 5 shows a flow chart that illustrates a method 500 for forming an encryption key in accordance with the present invention. Method 500 is implemented in software that can be executed by computer 100. As shown in FIG. 5, method 500 begins at step 510 by reading a randomly ordered sequence of bytes from a memory. The memory can include memory 110, or the magnetic, optical, magneto-optical, or electronic memory on a security card, disk, or other device.

The number of bytes in the randomly ordered sequence of bytes can be any number of bytes that is larger than the number of bytes required by the encryption key. However, the larger the number of bytes that are used in the randomly ordered sequence of bytes, the greater the randomness.

For example, when the encryption algorithm expects a 24 byte (192 bit) encryption key, the number of bytes in the randomly ordered sequence of bytes can be any number that is larger than 24 bytes. In the present invention, the scan of a security photograph can produce a 100.8 Mbyte file which, in turn, is significantly larger than the number of bytes required by the encryption key.

The number of bytes in the randomly ordered sequence of bytes is preferably a multiple of the number of bytes in the encryption key. For example, with a 24-byte encryption key, the number of bytes in the randomly ordered sequence of bytes preferably include, for example, 48 bytes (a multiple of two), 72 bytes (a multiple of three), and 100.8 Mbytes (a multiple of 4,200,000).

Sequences of bytes other than randomly ordered sequences of bytes can alternately be used, depending on the level of security that is required for the specific situation. For applications where a lower level of security is acceptable, method 500 can generate any sequence of bytes in step 510.

Next, method 500 moves to step 512 where each byte in the randomly ordered sequence of bytes is assigned to one of a number of groups. The number of groups, in turn, is determined by the number of bytes in the encryption key. For example, when the encryption algorithm expects a 24 byte (192 bit) encryption key, the randomly ordered sequence of bytes is divided into 24 groups. Thus, when the randomly ordered sequence is 100.8 Mbytes, each group has 4.2 Mbytes.

The bytes in the randomly ordered sequence of bytes can be assigned to groups in different ways. For example, the first 4.2 Mbytes can be assigned to the first group, the second 4.2 Mbytes can be assigned to the second group, while successive blocks of 4.2 Mbytes are assigned to successive groups.

Alternately, the first byte can be assigned to the first group, the second byte can be assigned to the second group, while successive bytes are assigned to successive groups. The process loops until each byte has been assigned to a group. Further, the bytes can be randomly assigned to groups.

If the randomly ordered sequence of bytes includes a number of bytes that is not evenly divisible with the number of bytes in the encryption key, the sequence has a number of extra bytes. For example, when the encryption algorithm expects a 24 byte encryption key and the randomly ordered sequence of bytes has 50 bytes, there are two extra bytes. (The extra bytes prevent the number from being evenly divisible).

The extra bytes, in turn, can be processed in a number of different ways. For example, the extra bytes can be truncated, or assigned to a group, randomly or according to a predefined procedure, such that not all of the groups have the same number of bytes.

In addition, if the number of bytes in the randomly ordered sequence of bytes is less than twice the number of bytes in the encryption key, a number of the groups have only one byte. For example, when the encryption algorithm expects a 24 byte encryption key and the randomly ordered sequence of bytes has 46 bytes, 22 groups have two bytes while 2 groups have one byte.

Once the groups have been formed, method 500 moves to step 514 where the number of bytes in each group of bytes is reduced to a single reduced byte. For example, when the encryption algorithm expects a 24 byte (192 bit) encryption key and the randomly ordered sequence of bytes has 100.8 Mbytes, the 100.8 Mbytes are divided into 24 groups of 4.2 Mbytes. The 4.2 Mbytes in each group are then reduced to a single reduced byte to form one byte of the 24-byte key.

The bytes in each group can be reduced to a single reduced byte in a number of ways, and are preferably reduced in a way where each byte in the group has an effect on the sequence of the resulting single reduced byte. For example, the base-10 value of each byte in a group can be summed together and divided by the number of bytes in the group to determine an average base-10 value. The binary representation of the average base-10 value can then be used to define the single reduced byte of the group.

Although less randomness results, the number of bytes in each group can be reduced to one without using each byte in the group. For example, each nth byte could be discarded before the average base-10 value is determined.

Once each group has been reduced to a single reduced byte, method 500 moves to step 516 where the single reduced bytes from the groups are assembled into a multi-byte file that becomes the encryption key for the encryption algorithm. The encryption key can then be internally stored in memory 110, externally stored on a medium (e.g., disk, magnetic strip), or used with the encryption algorithm to encrypt the data to be transferred or stored.

It should be understood that various alternatives to the method of the invention described herein may be employed in practicing the invention. Thus, it is intended that the following claims define the scope of the invention and that methods and structures within the scope of these claims and their equivalents be covered thereby.

What is claimed is:

1. A method of forming an encryption key that has a number of bytes, the method comprising the steps of:
reading a sequence of bytes from a memory, the sequence of bytes having a number of bytes that is greater than the number of bytes in the encryption key; and
reducing the number of bytes in the sequence of bytes to be equal to the number of bytes in the encryption key.

2. The method of claim 1 wherein the reducing step further includes the steps of:
assigning each byte in the sequence of bytes to one of a number of groups so that each group has one or more bytes, the number of groups being equal to the number of bytes in the encryption key; and
reducing the number of bytes in each group to a single byte.

3. The method of claim 2 wherein the reducing the number of bytes in each group to one byte step further includes the steps of:
determining a base-N value for each byte in a group;
summing together the base-N value of each byte in the group to form a base-N summed value; and
dividing the base-N summed value by the number of bytes in the group to determine a base-N average value, a base-2 representation of the base-N average value defining the single byte.

4. The method of claim 3 wherein the base-N is base-10.

5. The method of claim 1 and further comprising the steps of:
forming the sequence of bytes; and
storing the sequence of bytes in the memory.

6. The method of claim 5 wherein the sequence of bytes is formed by digitizing a unique image.

7. The method of claim 6 wherein the unique image is a magnified image of an interior of a gem.

8. The method of claim 5 wherein the sequence of bytes is formed by digitizing a recording of a unique sound event.

9. The method of claim 8 wherein the unique sound event is a recording of a voice stating a phrase.

10. The method of claim 2 and further comprising the steps of:
forming the sequence of bytes; and
storing the sequence of bytes in the memory.

11. The method of claim 10 wherein the sequence of bytes is formed by digitizing a unique image.

12. The method of claim 11 wherein the unique image is a magnified image of an interior of a gem.

13. The method of claim 10 wherein the sequence of bytes is formed by digitizing a recording of a unique sound event.

14. The method of claim 13 wherein the unique sound event is a recording of a voice stating a phrase.

15. The method of claim 1 wherein the number of bytes in the sequence of bytes is a multiple of the number of bytes in the encryption key.

16. The method of claim 15 wherein the reducing step further includes the steps of:
assigning each byte in the sequence of bytes to one of a number of groups so that each group has one or more bytes, the number of groups being equal to the number of bytes in the encryption key;
reducing the number of bytes in each group to a single byte.

17. The method of claim 16 and further comprising the steps of:
forming the sequence of bytes by digitizing a unique image; and
storing the sequence of bytes in the memory.

18. The method of claim 16 and further comprising the steps of:
forming the sequence of bytes by digitizing a unique sound event; and
storing the sequence of bytes in the memory.

19. An apparatus that forms an encryption key that has a number of bytes, the apparatus comprising:
means for reading a sequence of bytes from a memory, the sequence of bytes having a number of bytes that is greater than the number of bytes in the encryption key; and
means for reducing the number of bytes in the sequence of bytes to be equal to the number of bytes in the encryption key.

20. The apparatus of claim 19 wherein the means for reducing further includes:
means for assigning each byte in the sequence of bytes to one of a number of groups so that each group has one or more bytes, the number of groups being equal to the number of bytes in the encryption key; and
means for reducing the number of bytes in each group to a single byte.
